(19) United States
(12) Patent Application Publication
(10) Pub. No.: US 2025/0097028 A1
(43) Pub. Date: Mar. 20, 2025

(54) DISTRIBUTED MESSAGE AUTHENTICATION CODES FOR MULTIPLE PARTIES

(71) Applicant: Seagate Technology LLC, Fremont, CA (US)

(72) Inventors: Nolan Ashvin MIRANDA, Stanford, CA (US); Foo Yee YEO, Singapore (SG); Hwei Ming Jason YING, Singapore (SG)

(21) Appl. No.: 18/759,321

(22) Filed: Jun. 28, 2024

Related U.S. Application Data
(60) Provisional application No. 63/582,736, filed on Sep. 14, 2023.

(51) Int. Cl. H04L 9/08

(52) U.S. Cl. CPC H04L 9/088

(57) ABSTRACT

A computing system cryptographically generates an intermediate message authentication code as a function of the message and a cryptographic key assigned to a first party. The computing system also generates a first instance of an aggregate message authentication code corresponding to the message by combining the intermediate message authentication code with one or more other intermediate message authentication codes of one or more second parties. Each code of the one or more other intermediate message authentication codes is cryptographically generated as a function of the message and individual cryptographic key assigned to each of the one or more second parties.

### SUMMARY

In some aspects, the techniques described herein relate to a computing-processor-implemented method for processing a message using distributed message authentication codes, wherein the message is cryptographically verifiable, the computing-processor-implemented method including: cryptographically generating an intermediate message authentication code as a function of the message and a cryptographic key assigned to a first party; and generating a first instance of an aggregate message authentication code corresponding to the message by combining the intermediate message authentication code with one or more other intermediate message authentication codes of one or more second parties, wherein each code of the one or more other intermediate message authentication codes is cryptographically generated as a function of the message and individual cryptographic key assigned to each of the one or more second parties.

In some aspects, the techniques described herein relate to one or more tangible processor-readable storage media embodied with instructions for executing on one or more processors and circuits of a computing device a process for processing a message using distributed message authentication codes, wherein the message is cryptographically verifiable, the process including: cryptographically generating an intermediate message authentication code as a function of the message and a cryptographic key assigned to a first party; and generating a first instance of an aggregate message authentication code corresponding to the message by combining the intermediate message authentication code with one or more other intermediate message authentication codes of one or more second parties, wherein each code of the one or more other intermediate message authentication codes is cryptographically generated as a function of the message and individual cryptographic key assigned to each of the one or more second parties.

In some aspects, the techniques described herein relate to a computing system for processing a message using distributed message authentication codes, the computing system including: one or more hardware processors; a cryptographic generator executable by the one or more hardware processors and configured to cryptographically generate an intermediate message authentication code as a function of the message and a cryptographic key assigned to a first party; and a reconstructor generating executable by the one or more hardware processors and configured to generate a first instance of an aggregate message authentication code corresponding to the message by combining the intermediate message authentication code with one or more other intermediate message authentication codes of one or more second parties, wherein each code of the one or more other intermediate message authentication codes is cryptographically generated as a function of the message and individual cryptographic key assigned to each of the one or more second parties.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example application of distributed MACs.

FIG. 2 illustrates an example system and method for signing a message using distributed MACs.

FIG. 3 illustrates an example system and method for verifying a message using distributed MACs.

FIG. 4 illustrates example operations of a computer-processor-implemented method of processing a message involving distributed media authorization codes, wherein the message is cryptographically verifiable.

FIG. 5 illustrates an example computing device for use in implementing the described technology.

### DETAILED DESCRIPTIONS

Message authentication codes (or MACs for short), also sometimes called tags or message tags, are short pieces of cryptographic information that accompany longer messages. MACs are a way to verify message (and/or sender) authenticity. The idea is that the sender can cryptographically “sign” a message with a MAC using a cryptographic key, and a recipient (with the same key) can “verify” the MAC and make sure that the message was indeed sent by the expected sender. As a result, MACs are hard to forge: an adversary without the cryptographic key should not be able to forge a MAC for a message that would pass the verifier's test.

The described technology is directed to MAC signing (and, similarly, verification) involving multiple senders (and similarly, multiple verifiers) and introduces two different fast and secure approaches for using distributed MACs. Such distributed MACs are useful in many settings where some piece of data needs to be signed and/or verified by multiple parties. A first distributed MAC approach works for a fixed number of parties, and a second distributed MAC approach works even for a variable number of parties. In many implementations, the computation time needed by each party for generating the described distributable MACs is comparable to commonly used MACs.

As an example application, suppose that some data (e.g., that will be stored on a cloud service) is jointly owned by multiple parties, and each of these parties would like to verify the integrity of the information when it is retrieved to ensure that the data has not been tampered with. One solution will be for each party to compute a MAC on the data using a key they privately possess and append these multiple MACs to the stored data (e.g., sign a message). However, this is inefficient as it requires the storage and communication of multiple MACs. In contrast, distributed MACs will allow the parties to jointly sign the message before communicating it or storing it on the cloud service and then jointly verify the integrity when it is later received or retrieved. This means that only a single aggregated MAC needs to be stored with the data (rather than a series of appended MACs), thus improving storage and communication efficiency.

Another possible application for distributed MACs is when a sender of some information wishes to outsource MAC computation (for example, if there are a lot of messages being transmitted or if computing the MAC is resource-intensive). However, the sender cannot possibly share his MAC key with untrusted parties, as anyone in possession of the key will be able to create valid MACs. Instead, using distributed MACs, the sender can act as a dealer of cryptographic keys to a set of parties who can compute an aggregate MAC on the message without learning the cryptographic keys of the other parties. Similarly, a verifier can outsource verification as the dealer to a set of parties who also do not learn the keys of other parties.

With respect to the first distributed MAC approach, because MACs are, in a sense, hard to reverse-engineer (and therefore hard to forge), if each party calculates a MAC and these MACs are combined, the result is secure, and the aggregate MAC cannot be forged by any proper subset of the parties. When the number of parties is a fixed number, then it is sufficient to make an aggregate MAC by taking the same fixed number of different keys (one per party), having each party (e.g., each server) calculate a MAC of the message using their corresponding unique cryptographic key, and XORing the results together. The intuition is that because each MAC is hard to forge, the XOR of all of the MACs is hard to forge, and this is cryptographically provable.

Having a distributed MAC scheme for a variable number of parties opens up even more possibilities. With respect to the second distributed MAC approach, the sets of parties that are authorized to sign/verify the MAC can be arbitrarily specified in an access structure. With an appropriate choice of access structure, this approach, for example, allows for a set of senders to send a message to a different set of verifiers (whose size can be different from the number of senders), and each verifier can be convinced that the message is indeed sent by the set of senders.

When the number of signing/verifying parties (e.g., the number of parties that are signing a message and/or verifying a MAC) is not predetermined and fixed, the approach changes because the number of keys in the above protocol cannot be varied. Thus, some implementations of the second distributed MAC approach use the Carter-Wegman MAC, a fast, industry-standard MAC that essentially compresses a message (using a hash function), then masks it by adding a random-looking value (which is the output of a pseudo random function or PRF). This allows for a short aggregated MAC with a small key size and quick computation. By carefully choosing hash functions and PRFs with certain (homomorphic) properties to construct the Carter-Wegman MAC, both parts of the computation of the Carter-Wegman MAC (namely, hashing of the message and masking) can be distributed among a variable number of parties.

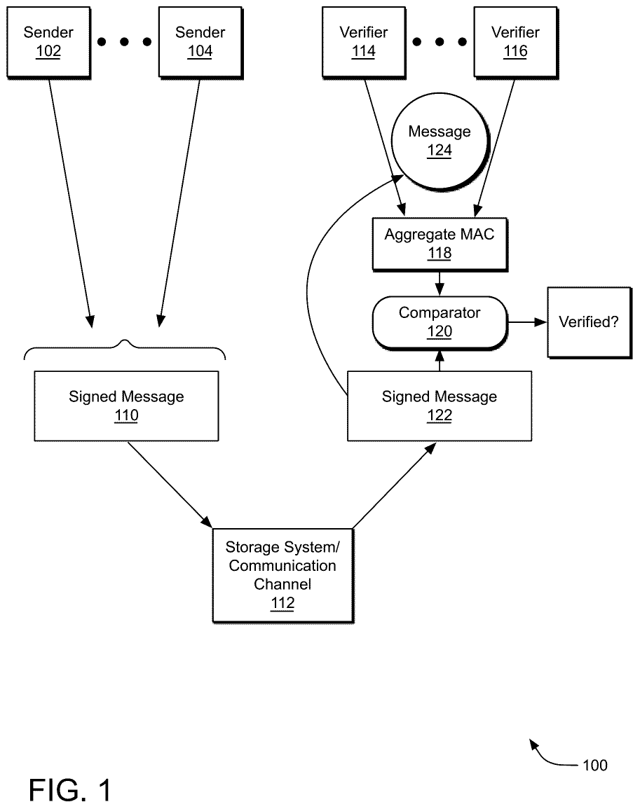

FIG. 1 illustrates an example application 100 of distributed MACs. The left side of FIG. 1 is directed to the sending and signing aspects of the described technology. Multiple senders (e.g., a sender 102 and a sender 104) come together to sign a message with an aggregate MAC. Each sender receives a unique cryptographic key (e.g., from a dealer), and a cryptographic generator of each sender generates a sender-specific MAC corresponding to the sender as a function of the corresponding cryptographic key and the message. The sender-specific MACs (e.g., distributed MACs) from the multiple senders are then combined by a reconstructor to create an aggregate MAC, which is used by a message signer to sign the message to yield a signed message 110. Any one or the senders or a third party can then store the signed message 110 in a storage system or communicate the signed message 110 via a communication channel (see storage system/communication channel 112).

The right side of FIG. 1 is directed to the receiving and verifying aspects of the described technology. Verification determines whether the message received from the storage system/communication channel 112 in a signed message 122 (e.g., retrieved from storage or received in communication) is the same message signed by the senders. Each verifier of a set of multiple verifiers (e.g., a verifier 114 and a verifier 116) receives a unique cryptographic key (e.g., from the dealer)—the same set of cryptographic keys as used by the multiple senders—and a cryptographic generator of each verifier generates a verifier-specific MAC corresponding to the verifier as a function of the corresponding cryptographic key and the message 124, which is extracted from the signed message 122. Thereafter, a constructor combines the verifier-specific MACs to generate an aggregate MAC 118, a new instance of the aggregated MAC based on the same cryptographic keys used by the senders to generate the sender MACs.

A comparator 120 compares an aggregate MAC received in the signed message 122 from the storage system/communication channel 112 with the aggregate MAC 118 generated by the multiple verifiers. If the aggregate MAC in the signed message 122 and the aggregate MAC 118 match (at least within an acceptable tolerance), the message is verified as being the same message that was signed by the multiple senders. Otherwise, if the aggregate MAC in the signed message 122 and the aggregate MAC 118 do not match (at least within an acceptable tolerance), then the message in the signed message 122 is not verified as the same message that was signed by the multiple senders.

It should be understood that “sender” and “verifier” represent roles in the application of distributed MACs. As such, a single party can play the role of a sender and/or a verifier. For example, a set of multiple parties can play the role of “senders” by storing a signed message in a storage system. Later, the same set of multiple parties can play the role of “verifiers” by retrieving the signed message from the storage system and verifying that it contains the same message as the message signed by those multiple parties when the signed message was stored in the storage system. Alternatively, the parties playing the role of “senders” may be different than the parties playing the role of “verifiers.” For example, a first set of multiple parties can play the role of “senders” by transmitting a signed message via a communication channel to a second set of multiple parties. Upon receipt of the signed message, the second set of the multiple parties plays the role of “verifiers” by receiving the signed message via the communication channel and verifying that it contains the same message as the message signed by the first set of multiple parties that transmitted the signed message.

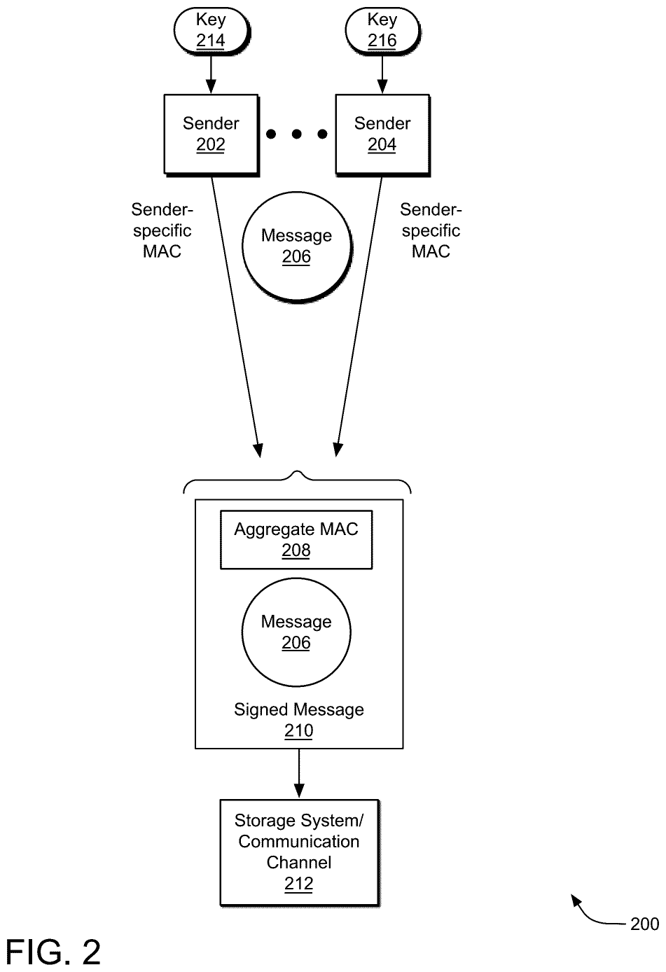

FIG. 2 illustrates an example system and method (collectively, a design 200) for signing a message using distributed MACs. Multiple senders (e.g., a sender 202 and a sender 204) come together to sign a message with an aggregate MAC 208. Each sender receives a unique cryptographic key (see, e.g., a key 214 and a key 216), such as from a dealer, and a cryptographic generator of each sender generates a sender-specific MAC (e.g., one of the multiple distributed MACs) corresponding to the sender as a function of the corresponding cryptographic key and the message. The sender-specific MACs from the multiple senders are then combined by a reconstructor to create an aggregate MAC 208, which is used by a message signer to sign the message 206 to yield a signed message 210. Any one or the senders or a third party can then store the signed message 210 in a storage system or communicate the signed message 210 via a communication channel (see storage system/communication channel 212). As described herein, the operations of storing in a storage system, communicating via a communication channel, and other forms of transferring a message or data between parties and/or from one party to itself at a later time are referred to as “communicating a message.”

The first set of implementations relates to the case in which the number of parties (e.g., the number of senders and the number of verifiers) are predetermined and fixed between the signing and the verifying operations. Suppose the MAC of a message is to be computed by n parties (e.g., senders) and also verified by n parties (e.g., verifiers). Let P₁, . . . , Pₙ be the parties computing the MAC 208 and let V₁, . . . , Vₙ be the parties verifying the aggregate MAC 208. Let MAC (k, m) represent a secure MAC function with cryptographic key k (e.g., key 214) for message m (e.g., message 206). The signing process proceeds as follows.
1. Generation: The dealer [symbol] takes n keys k₁, k₂, . . . , kₙ in the key space for the MAC function. [symbol] distributes kᵢ to party Pᵢ.
2. Evaluation: The parties collectively decide on a message m for which they want to calculate the MAC. Each party Pᵢ calculates their reconstruction share rᵢ=MAC (kᵢ, m).
3. Reconstruction: The parties come together and evaluate ⊕ᵢ₌₁^{k} rᵢ and output the result as the aggregate MAC 208 of m, where ⊕ represents an XOR operation on all of the reconstruction shares rᵢ for i=1 to k in various implementations. Other reconstruction operations may be employed.

The aggregate MAC 208 of the message 206 and the message 206 itself communicated together (e.g., the message 206 signed by a message signer) as the signed message 210 to a storage system or communications channel.

A second set of implementations relates to the case in which the number of senders and/or verifiers is not predetermined. A Carter-Wegman MAC function is used to generate a quick-to-compute MAC with a small key size, although other MAC functions may be employed in other implementations. The intuition behind the use of the Carter-Wegman MAC function is that if one takes a large message, hashes it to a smaller space, and then adds a random-looking (but small) mask to the result, the output looks random and is hard to forge even though this output may be considerably smaller than the original message.

Formally, the Carter-Wegman MAC can be defined as a function from [symbol] × [symbol] × [symbol] → [symbol] where:
[symbol] = [symbol] ₕ× [symbol] ₑ contains ordered pairs of keys, where [symbol] ₕ is a keyspace for a suitable hash function H, and [symbol] ₑ is a keyspace for a PRF F, where H: [symbol] ₙ× [symbol] → [symbol] and F: [symbol] ₑ× [symbol] → [symbol] ,
[symbol] is the message space that also serves as the input to H,
[symbol] is the space of nonces that also serves as the input to F, and
[symbol] is the tag space (e.g., the MAC space).

To calculate the Carter-Wegman MAC, one calculates

C(k,m,n)=C((kₕ,kₑ),m,n)=H(kₕ,m)⊕F(k,n)

and outputs the result.

The following description provides more detail regarding the generation of MACs and the signing of messages in this second scenario in which the number of senders and/or verifiers is not predetermined. Suppose the key space is a field [symbol] _{K} and the tag space (or MAC space) [symbol] is a field [symbol] _{T}. Let F: [symbol] _{K}× [symbol] → [symbol] _{T} be a key-homomorphic PRF:

$${\sum }_{i = 1}^{n} {k}_{i} = k implies {\sum }_{i = 1}^{n} F ( {k}_{i} , x ) = F ( k , x )$$

for all k∈ [symbol] ₑ and x∈ [symbol] . In practice, key-homomorphic PRFs are not perfect and tend to be almost key-homomorphic:

$${\sum }_{i = 1}^{n} {k}_{i} = k implies {\sum }_{i = 1}^{n} F ( {k}_{i} , x ) = F ( k , x ) + ϵ$$

for a small error term ϵ.

Because the Carter-Wegman MAC scheme allows the use of any Almost Universal (AXU) hash function, the described method uses the hash function

$$H : {𝔽}_{T} \times {𝔽}_{T} \to {𝔽}_{T}$$

given by H (τ, m)=τ·m for all τ∈ [symbol] _{T} (where · denotes field multiplication). The described method aims to distribute the Carter-Wegman MAC construction given by

$$C ( k , m , x ) = F ( k , x ) + H ( τ , {H}_{c} ( m ) )$$

where H_{c} denotes a collision-resistant hash function, such as SHA256 and x is the nonce for the calculation.

Let P₁, . . . , Pₙ be n parties for the distributed MAC computation scheme, let V₁, . . . , Vₙ, be the n′ verifiers for the scheme, and let D be the dealer for the scheme. Implementations of the method for generating the sender-specific MACs and the aggregate MAC 208 are described as follows:
1. Generation: The dealer D takes a key k∈ [symbol] ₑ= [symbol] _{K} and a field element τ∈ [symbol] ₕ= [symbol] _{T}. D generates
   k₁, . . . , kₙ such that Σᵢ₌₁ⁿ kᵢ=k, and
   τ₁, . . . , τₙ such that τᵢ₌₁ⁿ τᵢ=τ.
D distributes the share si=(kᵢ, Ti) to party Pᵢ.
2. Evaluation: The parties decide on a message m∈ [symbol] to sign with an aggregated MAC. Then, each party Pᵢ calculates rᵢ=F(kᵢ, x)+H_{c} (m)·τᵢ.
3. Reconstruction: All n parties come together and output (x, Σᵢ₌₁ⁿ rᵢ) as the aggregate MAC 208 on the message m. The parties (e.g., the senders) then increment their nonce x.

The aggregate MAC 208 of the message 206 and the message 206 itself are communicated together (e.g., the message 206 is signed by a message signer) as the signed message 210 to a storage system or communications channel.

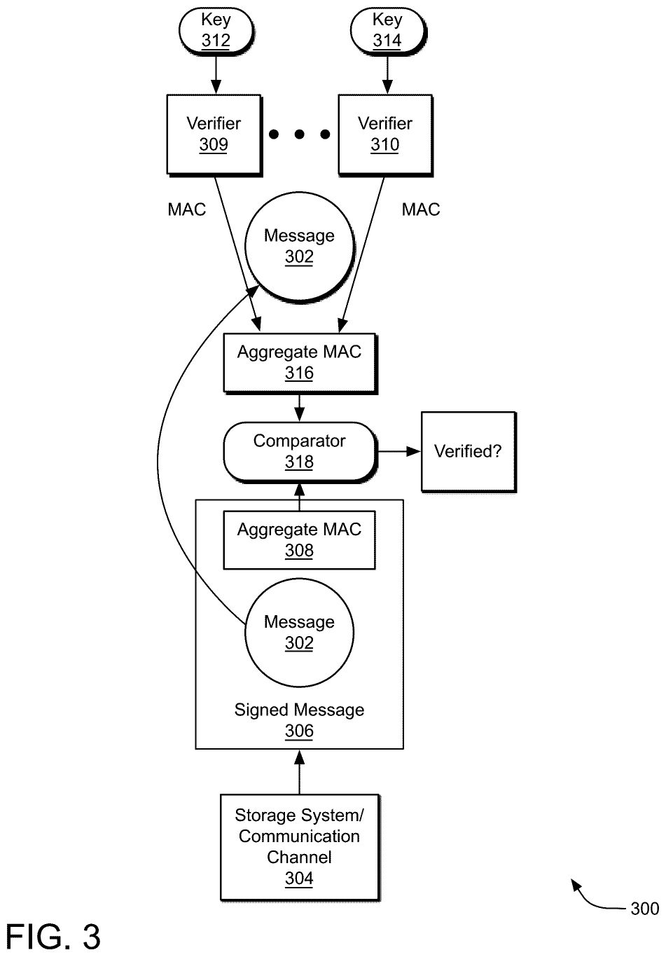

FIG. 3 illustrates an example system and method (collectively, a design 300) for verifying a message 302 using distributed MACs. Verification determines whether the message 302 received from a storage system/communication channel 304 in a signed message 306 (e.g., retrieved from storage or received in communication) is the same message signed by the senders. Each verifier of a set of multiple verifiers (e.g., a verifier 309 and a verifier 310) a unique cryptographic key (see, e.g., a key 312 and a key 314), such as from a dealer—the same set of cryptographic keys as used by the multiple senders—and generates a verifier-specific MAC (e.g., one of the multiple distributed MACs) corresponding to the verifier as a function of the corresponding cryptographic key and the message 302, which is extracted from the signed message 306. Thereafter, a reconstructor combines the verifier-specific MACs to generate an aggregate MAC 316, a new instance of the aggregated MAC based on the same cryptographic keys used by the senders to generate the sender-specific MACs.

A comparator 318 compares an aggregate MAC 308 received in the signed message 306 from the storage system/communication channel 304 with the aggregate MAC 316 generated by the multiple verifiers. If the aggregate MAC 308 in the signed message 306 and the aggregate MAC 316 match (at least within an acceptable tolerance), the message 302 is verified as being the same message that was signed by the multiple senders. Otherwise, if the aggregate MAC 308 in the signed message 306 and the aggregate MAC 316 do not match (at least within an acceptable tolerance), then the message 302 in the signed message 306 is not verified as the same message that was signed by the multiple senders.

Again, the first set of implementations relates to the case in which the number of parties (e.g., the number of senders and the number of verifiers) are predetermined and fixed between the signing and the verifying operations. This protocol is similar to the previous computation used in the sending process of a signed message. Suppose the verifiers are trying to verify that a message m has a MAC or tag t.
1. Generation: The dealer [symbol] takes the n keys k₁, k₂, . . . , kₙ used for creating the MAC on m. [symbol] distributes kᵢ to a verifier Vᵢ.
2. Evaluation: The verifiers take the message m for which they want to verify the MAC. Each verifier Vᵢ calculates their reconstruction share vᵢ=MAC (kᵢ, m).
3. Reconstruction: The verifiers come together, evaluate ⊕ᵢ₌₁^{k} vᵢ and check if the result (the aggregate MAC 316) is the same as the received tag t (the aggregate MAC 308), where ⊕ represents an XOR operation on all of the reconstruction shares vᵢ for i=1 to k in various implementations. Accordingly, where the number of sending parties signing the message and the number of verifying parties verifying the message are predefined and fixed, the difference margin is zero. Other reconstruction operations may be employed.

Note that the resulting aggregate MAC has the size of the output of the original MAC scheme, so the length is not a concern. In addition, it can be proved that the XOR of secure MAC outputs is a secure MAC on the original message.

Again, the second set of implementations relates to the case in which the number of senders and verifiers is not predetermined and fixed. Let m be the message with MAC or tag (x, t) for verification.
1. Generation: The dealer D takes the key k∈ [symbol] ₑ= [symbol] _{K} and the field element τ∈ [symbol] ₕ= [symbol] _{T} used for the original MAC computation. D generates
   k₁, . . . , kₙ, such that Σⱼ₌₁^{n′} kⱼ=k, and
   τ₁, . . . , τₙ, such that Σⱼ₌₁^{n′} τⱼ=τ.
The dealer D distributes the share sⱼ=(kⱼ, τⱼ) to a verifier Vⱼ.
2. Evaluation: Each verifier Vⱼ calculates rⱼ=F (kⱼ, x)+H_{c} (m)·τⱼ.
3. Reconstruction: All n′ verifiers come together and calculate Σⱼ₌₁^{n′} rⱼ. The result is then evaluated to determine whether the result is within (n+n′)∈ of t (this bound is referred to as a “difference margin”). Accordingly, when the number of sending parties signing the message and the number of verifying parties verifying the message are not predetermined and fixed, the difference margin is dependent on the sum of the number of sending parties signing the message and the number of verifying parties. A true or “verified” result is returned after this evaluation is determined to be true, and a false or “unverified” result is returned after this evaluation is determined to be false.

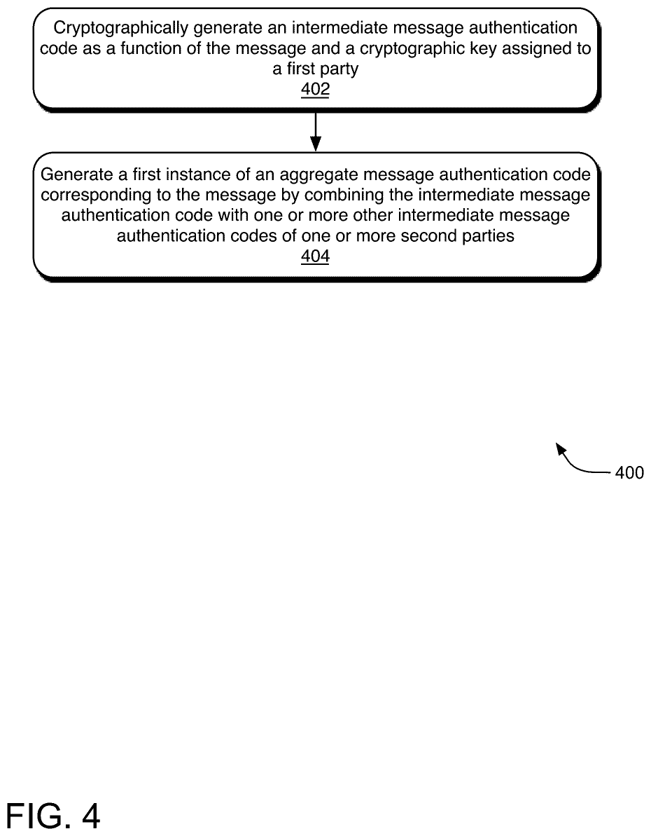

FIG. 4 illustrates example operations 400 of a computer-processor-implemented method of processing a message involving distributed media authorization codes, wherein the message is cryptographically verifiable. A first generating operation 402 cryptographically generates an intermediate message authentication code as a function of the message and a cryptographic key assigned to a first party. A second generating operation 404 generates a first instance of an aggregate message authentication code corresponding to the message by combining the intermediate message authentication code with one or more other intermediate message authentication codes of one or more second parties. Each code of the one or more other intermediate message authentication codes is cryptographically generated as a function of the message and individual cryptographic key assigned to each of the one or more second parties.

In some implementations, the first party and the one or more second parties constitute multiple sending parties, and the computing-processor-implemented method includes signing the message with the first instance of the aggregate message authentication code to yield a signed message.

In other implementations, the first party and the one or more second parties constitute multiple sending parties, and the computing-processor-implemented method includes receiving the message and a second instance of the aggregate message authentication code. The second instance of the aggregate message authentication code is generated from the intermediate message authentication codes of multiple sending parties. The computing-processor-implemented method also includes comparing the first instance of the aggregate message authentication code to the second instance of the aggregate message authentication code, wherein the message is verified when the first instance of the aggregate message authentication code to the second instance of the aggregate message authentication code match within a difference margin.

In other implementations, a cryptographically generating operation includes cryptographically generating an intermediate message authentication code as a function of the message and a cryptographic key assigned to a first party using a Carter-Wegman message authentication code generation function.

In other implementations, the number of sending parties signing the message and the number of verifying parties verifying the message are different and cryptographically generating includes cryptographically generating an intermediate message authentication code as a function of the message and a cryptographic key assigned to a first party using a Carter-Wegman message authentication code generation function and a key-homomorphic pseudo-random function.

In other implementations, the combining includes performing an XOR operation on the intermediate message authentication code and the one or more other intermediate message authentication codes.

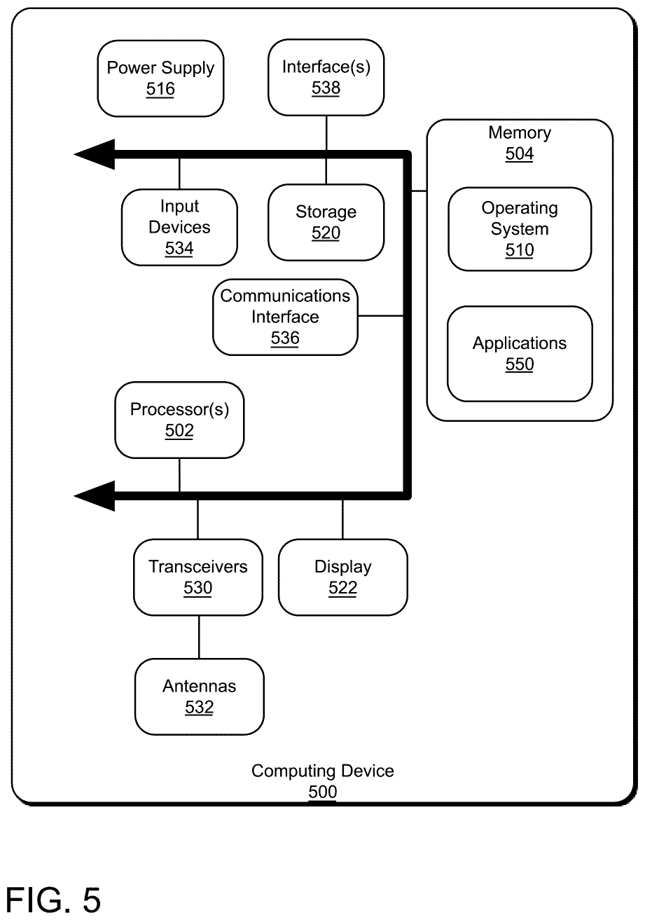

FIG. 5 illustrates an example computing device 500 for use in implementing the described technology. The computing device 500 may be a client computing device (such as a laptop computer, a desktop computer, or a tablet computer), a server/cloud computing device, an Internet-of-Things (IoT), any other type of computing device, or a combination of these options. The computing device 500 includes one or more hardware processor(s) 502 and a memory 504. The memory 504 generally includes both volatile memory (e.g., RAM) and nonvolatile memory (e.g., flash memory), although one or the other type of memory may be omitted. An operating system 510 resides in the memory 504 and is executed by the processor(s) 502. In some implementations, the computing device 500 includes and/or is communicatively coupled to storage 520.

In the example computing device 500, as shown in FIG. 5, one or more software modules, segments, and/or processors, such as applications 550, a cryptographic generator, a reconstructor, a message signer, a comparator, and other program code and modules are loaded into the operating system 510 on the memory 504 and/or the storage 520 and executed by the processor(s) 502. The storage 520 may store cryptographic keys, messages, message authentication codes, verification results, and other data and be local to the computing device 500 or may be remote and communicatively connected to the computing device 500. In particular, in one implementation, components of a system for processing a message involving distributed message authentication codes may be implemented entirely in hardware or in a combination of hardware circuitry and software.

The computing device 500 includes a power supply 516, which may include or be connected to one or more batteries or other power sources, and which provides power to other components of the computing device 500. The power supply 516 may also be connected to an external power source that overrides or recharges the built-in batteries or other power sources.

The computing device 500 may include one or more communication transceivers 530, which may be connected to one or more antenna(s) 532 to provide network connectivity (e.g., mobile phone network, Wi-Fi®, Bluetooth®) to one or more other servers, client devices, IoT devices, and other computing and communications devices. The computing device 500 may further include a communications interface 536 (such as a network adapter or an I/O port, which are types of communication devices). The computing device 500 may use the adapter and any other types of communication devices for establishing connections over a wide-area network (WAN) or local-area network (LAN). It should be appreciated that the network connections shown are exemplary and that other communications devices and means for establishing a communications link between the computing device 500 and other devices may be used.

The computing device 500 may include one or more input devices 534 such that a user may enter commands and information (e.g., a keyboard, trackpad, or mouse). These and other input devices may be coupled to the server by one or more interfaces 538, such as a serial port interface, parallel port, or universal serial bus (USB). The computing device 500 may further include a display 522, such as a touchscreen display.

The computing device 500 may include a variety of tangible processor-readable storage media and intangible processor-readable communication signals. Tangible processor-readable storage can be embodied by any available media that can be accessed by the computing device 500 and can include both volatile and nonvolatile storage media and removable and non-removable storage media. Tangible processor-readable storage media includes non-transitory media and excludes intangible and transitory communications signals (such as signals per se) and includes volatile and nonvolatile, removable and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 500. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A computing-processor-implemented method for processing a message involving distributed message authentication codes, wherein the message is cryptographically verifiable, the computing-processor-implemented method comprising: cryptographically generating an intermediate message authentication code as a function of the message and a cryptographic key assigned to a first party; and generating a first instance of an aggregate message authentication code corresponding to the message by combining the intermediate message authentication code with one or more other intermediate message authentication codes of one or more second parties, wherein each code of the one or more other intermediate message authentication codes is cryptographically generated as a function of the message and individual cryptographic key assigned to each of the one or more second parties.

Clause 2. The computing-processor-implemented method of clause 1, wherein the first party and the one or more second parties constitute multiple sending parties and further comprising: signing the message with the first instance of the aggregate message authentication code to yield a signed message.

Clause 3. The computing-processor-implemented method of clause 1, wherein the first party and the one or more second parties constitute multiple sending parties and further comprising: receiving the message and a second instance of the aggregate message authentication code, the second instance of the aggregate message authentication code being generated from intermediate message authentication codes of multiple sending parties; and comparing the first instance of the aggregate message authentication code to the second instance of the aggregate message authentication code, wherein the message is verified when the first instance of the aggregate message authentication code to the second instance of the aggregate message authentication code match within a difference margin.

Clause 4. The computing-processor-implemented method of clause 3, wherein a number of sending parties signing the message and a number of verifying parties verifying the message are fixed and the difference margin is zero.

Clause 5. The computing-processor-implemented method of clause 3, wherein a number of sending parties signing the message and a number of verifying parties verifying the message are different and the difference margin is dependent on a sum of a number of sending parties signing the message and a number of verifying parties.

Clause 6. The computing-processor-implemented method of clause 1, wherein cryptographically generating comprises: cryptographically generating an intermediate message authentication code as a function of the message and a cryptographic key assigned to a first party using a Carter-Wegman message authentication code generation function.

Clause 7. The computing-processor-implemented method of clause 1, wherein a number of sending parties signing the message and a number of verifying parties verifying the message are different and cryptographically generating comprises: cryptographically generating an intermediate message authentication code as a function of the message and a cryptographic key assigned to a first party using a Carter-Wegman message authentication code generation function and a key-homomorphic pseudo-random function.

Clause 8. The computing-processor-implemented method of clause 1, wherein combining comprises: performing an XOR operation on the intermediate message authentication code and the one or more other intermediate message authentication codes.

Clause 9. One or more tangible processor-readable storage media embodied with instructions for executing on one or more processors and circuits of a computing device a process for processing a message involving distributed message authentication codes, wherein the message is cryptographically verifiable, the process comprising: cryptographically generating an intermediate message authentication code as a function of the message and a cryptographic key assigned to a first party; and generating a first instance of an aggregate message authentication code corresponding to the message by combining the intermediate message authentication code with one or more other intermediate message authentication codes of one or more second parties, wherein each code of the one or more other intermediate message authentication codes is cryptographically generated as a function of the message and individual cryptographic key assigned to each of the one or more second parties.

Clause 10. The one or more tangible processor-readable storage media of clause 9, wherein the first party and the one or more second parties constitute multiple sending parties and the process further comprises: signing the message with the first instance of the aggregate message authentication code to yield a signed message.

Clause 11. The one or more tangible processor-readable storage media of clause 9, wherein the first party and the one or more second parties constitute multiple sending parties and further comprising: receiving the message and a second instance of the aggregate message authentication code, the second instance of the aggregate message authentication code being generated from intermediate message authentication codes of multiple sending parties; and comparing the first instance of the aggregate message authentication code to the second instance of the aggregate message authentication code, wherein the message is verified when the first instance of the aggregate message authentication code to the second instance of the aggregate message authentication code match within a difference margin.

Clause 12. The one or more tangible processor-readable storage media of clause 11, wherein a number of sending parties signing the message and a number of verifying parties verifying the message are fixed and the difference margin is zero.

Clause 13. The one or more tangible processor-readable storage media of clause 11, wherein a number of sending parties signing the message and a number of verifying parties verifying the message are different and the difference margin is dependent on a sum of a number of sending parties signing the message and a number of verifying parties.

Clause 14. The one or more tangible processor-readable storage media of clause 9, wherein cryptographically generating comprises: cryptographically generating an intermediate message authentication code as a function of the message and a cryptographic key assigned to a first party using a Carter-Wegman message authentication code generation function.

Clause 15. The one or more tangible processor-readable storage media of clause 9, wherein a number of sending parties signing the message and a number of verifying parties verifying the message are different and cryptographically generating comprises: cryptographically generating an intermediate message authentication code as a function of the message and a cryptographic key assigned to a first party using a Carter-Wegman message authentication code generation function and a key-homomorphic pseudo-random function.

Clause 16. The one or more tangible processor-readable storage media of clause 9, wherein combining comprises: performing an XOR operation on the intermediate message authentication code and the one or more other intermediate message authentication codes.

Clause 17. A computing system for processing a message involving distributed message authentication codes, the computing system comprising: one or more hardware processors; a cryptographic generator executable by the one or more hardware processors and configured to cryptographically generate an intermediate message authentication code as a function of the message and a cryptographic key assigned to a first party; and a reconstructor generating executable by the one or more hardware processors and configured to generate a first instance of an aggregate message authentication code corresponding to the message by combining the intermediate message authentication code with one or more other intermediate message authentication codes of one or more second parties, wherein each code of the one or more other intermediate message authentication codes is cryptographically generated as a function of the message and individual cryptographic key assigned to each of the one or more second parties.

Clause 18. The computing system of clause 17, wherein the first party and the one or more second parties constitute multiple sending parties, and further comprising: a message signer executable by the one or more hardware processors and configured to sign the message with the first instance of the aggregate message authentication code to yield a signed message.

Clause 19. The computing system of clause 17, wherein the first party and the one or more second parties constitute multiple sending parties, and further comprising: a comparator executable by the one or more hardware processors and configured to receive the message and a second instance of the aggregate message authentication code, the second instance of the aggregate message authentication code being generated from intermediate message authentication codes of multiple sending parties, the message evaluated being further configured to compare the first instance of the aggregate message authentication code to the second instance of the aggregate message authentication code, wherein the message is verified when the first instance of the aggregate message authentication code to the second instance of the aggregate message authentication code match within a difference margin.

Clause 20. The computing system of clause 17, wherein the cryptographic generator is configured to cryptographically generate an intermediate message authentication code as a function of the message and a cryptographic key assigned to a first party using a Carter-Wegman message authentication code generation function.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A computing-processor-implemented method for processing a message involving distributed message authentication codes, wherein the message is cryptographically verifiable, the computing-processor-implemented method comprising:
cryptographically generating an intermediate message authentication code as a function of the message and a cryptographic key assigned to a first party; and
generating a first instance of an aggregate message authentication code corresponding to the message by combining the intermediate message authentication code with one or more other intermediate message authentication codes of one or more second parties, wherein each code of the one or more other intermediate message authentication codes is cryptographically generated as a function of the message and individual cryptographic key assigned to each of the one or more second parties.

2. The computing-processor-implemented method of claim 1, wherein the first party and the one or more second parties constitute multiple sending parties and further comprising:
signing the message with the first instance of the aggregate message authentication code to yield a signed message.

3. The computing-processor-implemented method of claim 1, wherein the first party and the one or more second parties constitute multiple sending parties and further comprising:
receiving the message and a second instance of the aggregate message authentication code, the second instance of the aggregate message authentication code being generated from intermediate message authentication codes of multiple sending parties; and
comparing the first instance of the aggregate message authentication code to the second instance of the aggregate message authentication code, wherein the message is verified when the first instance of the aggregate message authentication code to the second instance of the aggregate message authentication code match within a difference margin.

4. The computing-processor-implemented method of claim 3, wherein a number of sending parties signing the message and a number of verifying parties verifying the message are fixed and the difference margin is zero.

5. The computing-processor-implemented method of claim 3, wherein a number of sending parties signing the message and a number of verifying parties verifying the message are different and the difference margin is dependent on a sum of a number of sending parties signing the message and a number of verifying parties.

6. The computing-processor-implemented method of claim 1, wherein cryptographically generating comprises:
cryptographically generating an intermediate message authentication code as a function of the message and a cryptographic key assigned to a first party using a Carter-Wegman message authentication code generation function.

7. The computing-processor-implemented method of claim 1, wherein a number of sending parties signing the message and a number of verifying parties verifying the message are different and cryptographically generating comprises:
cryptographically generating an intermediate message authentication code as a function of the message and a cryptographic key assigned to a first party using a Carter-Wegman message authentication code generation function and a key-homomorphic pseudo-random function.

8. The computing-processor-implemented method of claim 1, wherein combining comprises:
performing an XOR operation on the intermediate message authentication code and the one or more other intermediate message authentication codes.

9. One or more tangible processor-readable storage media embodied with instructions for executing on one or more processors and circuits of a computing device a process for processing a message involving distributed message authentication codes, wherein the message is cryptographically verifiable, the process comprising:
cryptographically generating an intermediate message authentication code as a function of the message and a cryptographic key assigned to a first party; and
generating a first instance of an aggregate message authentication code corresponding to the message by combining the intermediate message authentication code with one or more other intermediate message authentication codes of one or more second parties, wherein each code of the one or more other intermediate message authentication codes is cryptographically generated as a function of the message and individual cryptographic key assigned to each of the one or more second parties.

10. The one or more tangible processor-readable storage media of claim 9, wherein the first party and the one or more second parties constitute multiple sending parties and the process further comprises:
signing the message with the first instance of the aggregate message authentication code to yield a signed message.

11. The one or more tangible processor-readable storage media of claim 9, wherein the first party and the one or more second parties constitute multiple sending parties and further comprising:
receiving the message and a second instance of the aggregate message authentication code, the second instance of the aggregate message authentication code being generated from intermediate message authentication codes of multiple sending parties; and
comparing the first instance of the aggregate message authentication code to the second instance of the aggregate message authentication code, wherein the message is verified when the first instance of the aggregate message authentication code to the second instance of the aggregate message authentication code match within a difference margin.

12. The one or more tangible processor-readable storage media of claim 11, wherein a number of sending parties signing the message and a number of verifying parties verifying the message are fixed and the difference margin is zero.

13. The one or more tangible processor-readable storage media of claim 11, wherein a number of sending parties signing the message and a number of verifying parties verifying the message are different and the difference margin is dependent on a sum of a number of sending parties signing the message and a number of verifying parties.

14. The one or more tangible processor-readable storage media of claim 9, wherein cryptographically generating comprises:
cryptographically generating an intermediate message authentication code as a function of the message and a cryptographic key assigned to a first party using a Carter-Wegman message authentication code generation function.

15. The one or more tangible processor-readable storage media of claim 9, wherein a number of sending parties signing the message and a number of verifying parties verifying the message are different and cryptographically generating comprises:
cryptographically generating an intermediate message authentication code as a function of the message and a cryptographic key assigned to a first party using a Carter-Wegman message authentication code generation function and a key-homomorphic pseudo-random function.

16. The one or more tangible processor-readable storage media of claim 9, wherein combining comprises:
performing an XOR operation on the intermediate message authentication code and the one or more other intermediate message authentication codes.

17. A computing system for processing a message involving distributed message authentication codes, the computing system comprising:
one or more hardware processors;
a cryptographic generator executable by the one or more hardware processors and configured to cryptographically generate an intermediate message authentication code as a function of the message and a cryptographic key assigned to a first party; and
a reconstructor generating executable by the one or more hardware processors and configured to generate a first instance of an aggregate message authentication code corresponding to the message by combining the intermediate message authentication code with one or more other intermediate message authentication codes of one or more second parties, wherein each code of the one or more other intermediate message authentication codes is cryptographically generated as a function of the message and individual cryptographic key assigned to each of the one or more second parties.

18. The computing system of claim 17, wherein the first party and the one or more second parties constitute multiple sending parties, and further comprising:
a message signer executable by the one or more hardware processors and configured to sign the message with the first instance of the aggregate message authentication code to yield a signed message.

19. The computing system of claim 17, wherein the first party and the one or more second parties constitute multiple sending parties, and further comprising:
a comparator executable by the one or more hardware processors and configured to receive the message and a second instance of the aggregate message authentication code, the second instance of the aggregate message authentication code being generated from intermediate message authentication codes of multiple sending parties, the message evaluated being further configured to compare the first instance of the aggregate message authentication code to the second instance of the aggregate message authentication code, wherein the message is verified when the first instance of the aggregate message authentication code to the second instance of the aggregate message authentication code match within a difference margin.

20. The computing system of claim 17, wherein the cryptographic generator is configured to cryptographically generate an intermediate message authentication code as a function of the message and a cryptographic key assigned to a first party using a Carter-Wegman message authentication code generation function.
